(19) United States
(12) Patent Application Publication
(10) Pub. No.: US 2005/0157764 A1
(43) Pub. Date: Jul. 21, 2005

(54) Laser element with laser-active medium

(75) Inventors: Daniel Kopf, Altach (AT); Maximilian J. Lederer, Alberschwende (AT)

Correspondence Address: OLIFF & BERRIDGE, PLC, P.O. BOX 19928, ALEXANDRIA, VA, 22320, US

(73) Assignee: High Q Laser Production GmbH, Hohenems (AT)

(21) Appl. No.: 10/973,341

(22) Filed: Oct. 27, 2004

(30) Foreign Application Priority Data
Oct. 27, 2003 (DE) 203 16 550.0

(51) Int. Cl. H01S 3/04; H01S 3/14

(52) U.S. Cl. 372/39

(57) ABSTRACT

By forming a laser element by embedding a laser-active medium in components of a heat-conducting crystalline material, an improved cooling effect can be achieved. As far as possible loss-free passage of the beam is achieved by a suitable orientation of interfaces and/or the use of antireflection coats or coatings.

The invention relates to a laser element according to the preamble of claim 1.

A basic requirement with respect to laser setups for industrial as well as scientific application is as high an input of power as possible into a laser-active medium. In a widely used type of solid-state lasers, this is effected by pumping by means of light which is emitted by one or more semiconductor lasers and is guided to the solid with or of laser-active material. During the pumping, the solid heats up so that an increased power input is associated with a basically undesired temperature increase.

The problems due to thermal loads arise in these systems on the one hand through damage to the solid itself or owing to undesired influences on the radiation field in the solid. Thermal lenses are an example of such an effect.

A critical parameter influencing these effects is the heat conduction within the solid, as well as the heat transport through the interfaces or boundary lasers of the laser-active solid. For example, thin-disk lasers, as disclosed, for example, in EP 0 632 551 B1, constitute a standard solution for reducing the thermal effects.

In such lasers, the laser medium is in the form of a flat disk and is mounted with one of its flat sides on a temperature sink which is generally in the form of a solid cooling element. Owing to the advantageous ratio of surface area to volume, it is also possible to achieve in the case of high transport efficiencies heat transport which produces sufficient cooling of the laser medium and thus prevents negative effects on material and radiation field.

Solutions of the prior art, as also disclosed, for example, in “Widely tunable pulse durations from a passively mode-locked thin-disk Yb:YAG laser”, F. Brunner et al. (Optics Letters 26, No. 2, pages 379-381) or “60-W average power in 810-fs pulses from a thin-disk Yb:YAG laser”, E. Innerhofer et al. (Optics Letters 28, No. 5, pages 367-369), intend to achieve optimization of the ratio of surface area to volume by keeping one dimension of the laser medium as small as possible but the other two dimensions as large as possible, but at least substantially larger than the thickness of the laser medium. The heat transport from the laser medium takes place via the contact with the temperature sink or with the surrounding air.

Temperature sinks used are metal or diamond surfaces which, on the one hand, have a heat-conducting connection to the laser-active material. Owing to the good thermal conductivity in combination with the electrical insulating power, in particular diamond heat spreaders are increasingly being used for cooling high-performance components, such as laser diodes.

In the case of a temperature sink contacted on one side, solutions of the prior art improve the heat transport through an optimized geometry of the laser medium, which for this purpose is as extensive as possible. However, owing to the thermodynamic conditions and technical circumstances in a laser resonator, the maximum cooling effect which can be realized thereby is limited.

It is therefore the object of the invention to provide a device which permits improved cooling of a laser medium.

A further object is to permit higher power input at the same maximum temperature of the laser medium.

A further object is to obtain a lower maximum temperature or a smaller effect of a thermal lens at the same power input.

These objects are achieved, according to the invention, by features of claim 1 and by the characterizing features of the subclaims, or the solutions are developed.

The inventive achievement of these objects or the development thereof is effected by the use of a cooling element or of a cooling layer comprising diamond, which has a direct heat-conducting connection to the laser-active medium. Here, multiple utilization of the Brewster condition in the beam path is made use of by the choice of suitable parameters, such as refractive index and layer geometry.

The combination of diamond elements and laser material to give a laser element can be effected by means of sandwiches of the laser-active medium between two diamond disks, so that individual elements are connected to one another, for example by diffusion bonding or by means of a purely mechanical holder. Alternatively or in addition, however, a layer can also be set up directly on the laser medium. Suitable methods, such as, for example, gas-phase deposition (CVD), are available for this purpose.

By applying such diamond elements to the laser-active medium, the number of surfaces or interfaces is increased so that more reflections, such as, for example, Fresnel reflections at the material transitions, occur. In order to avoid the associated losses, the structure of the laser element comprising laser-active material and cooling diamond elements is such that they are carefully tailored to one another. In addition, further layers, for example antireflection coatings, may be integrated in the structure of the laser element.

The design according to the invention is further explained with reference to the embodiments shown in the drawings, the description being intended to be purely by way of example, with reference to working examples shown schematically in the drawing. Specifically,

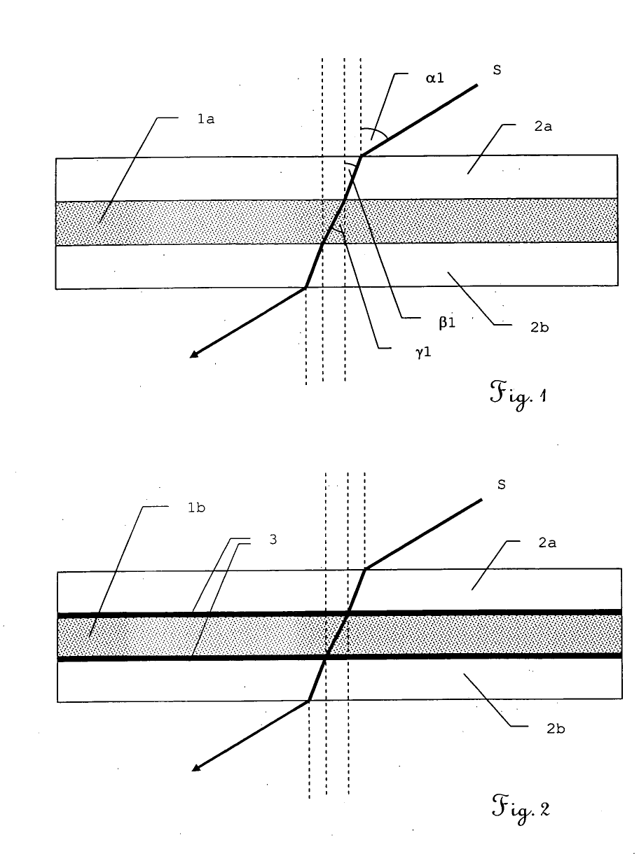

FIG. 1 shows the schematic diagram of a first embodiment of a laser element according to the invention;

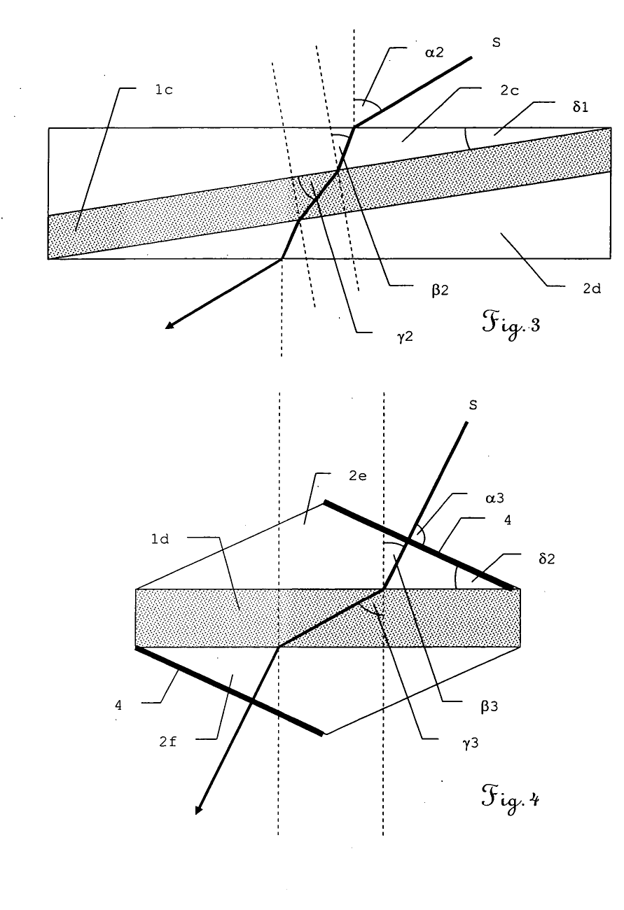

FIG. 2 shows the schematic diagram of a second embodiment of a laser element according to the invention, having additional antireflection coatings;

FIG. 3 shows the schematic diagram of a third embodiment of a laser element according to the invention, having wedge-shaped diamond elements;

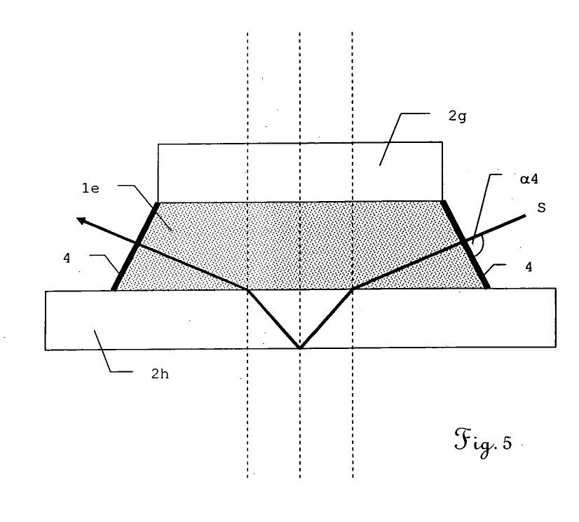

FIG. 4 shows the schematic diagram of a fourth embodiment of a laser element according to the invention, having diamond elements with a triangular cross-section, and

FIG. 5 shows the schematic diagram of a fifth embodiment of a laser element according to the invention, having a laser-active medium with a trapezoidal cross-section.

FIG. 1 shows a first embodiment of the laser element according to the invention, which consists of a laser-active medium 1a between a first component 2a and a second component 2b of optical diamond C₆ in a sandwich construction. In this embodiment, the three structural elements of the laser element are in the form of disks or strips having a corresponding cross-section and extensive contact. In this embodiment, all interfaces are parallel. In contrast, however, different cross-sections and shapes of the elements can in principle be chosen according to the invention. In this example, Nd:VAN, which emits at 1064 nm, 916 nm and 1.34 μm, is used as laser-active medium 1a. The refractive index of this material is n=2.16. The two diamond components have a refractive index of n=2.4, so that a p-polarized light beam S incident at a first angle α1 of about 67.380 satisfies the Brewster condition. The light beam S is then incident on the interface between the first component 2a and, the laser-active medium 1a at an angle β1 of about 22.60 which does not exactly correspond to the Brewster condition for the two media, but the reflection loss at this transition is calculated as 0.17%, which is negligible. For the interface between laser-active medium 1a and the second component 2b, the same applies for symmetry reasons.

The parameters stated purely by way of example, in particular the angle data, are based on the combination of diamond and a specific laser-active medium. Depending on the laser-active medium or light wavelength used, however, other angles or geometries may result. To this extent, the descriptions and data are to be understood as being purely by way of example, and the required calculations and adaptations for specific conversion of the concept according to the invention to a specific embodiment are within the scope of a person skilled in the art.

FIG. 2 shows a second inventive embodiment of the laser element which, in its design, resembles the first embodiment. In the case of laser-active media 1b having a refractive index n<2, achieving a geometry with parallel boundary layers which permits approximate compliance with the Brewster condition for all boundary layers or leads to negligible transition losses may be problematic. Two antireflection coatings 3 minimizing the Fresnel reflection are therefore introduced between the first component 2a and the laser-active medium 1b and between the laser-active medium 1a and the second component 2b. These antireflection coatings 3 have a reflectivity of R<0.15%, for example at an angle of incidence of 67°. This embodiment is particularly suitable for laser media having n<2.0, such as, for example, n=1.5. In an embodiment comprising such a refractive index configuration, the reflection-minimizing Brewster condition is complied with only at the interfaces at the entrance to and exit from the laser element. Here, the antireflection coating 3 is an alternative to the use of second or third angles with compliance with the Brewster condition, so that laser-active media 1b having a low refractive index can also be operated without large losses using diamond cooling according to the invention.

Alternatively, however, the application (not shown here) of the antireflection coatings to the outer interfaces of the first and second components and hence to the outside of the laser element can also be effected so that entry into the laser element at these boundary layers need not take place in compliance with the Brewster condition. The inner transition between first component and laser-active medium and between laser-active medium and second component once again occurs in compliance with the Brewster condition. The use of the antireflection coatings or antireflection coatings therefore makes it possible to dispense with compliance with the Brewster condition at selected interfaces, so that a certain freedom of geometry design is obtained.

FIG. 3 shows a third embodiment of the laser element according to the invention, in which a laser-active medium 1c having a refractive index n<2 can likewise be used, but no antireflection coatings are introduced into the laser element. In this embodiment, compliance with the Brewster condition is achieved for all interfaces by a nonparallel design of these interfaces. The laser-active medium 1c having a refractive index of n<2 is arranged between a first component 2c and a second component 2d of optical diamond C₆ in a sandwich construction. In this embodiment, the first component 2c and the second component 2d are wedge-shaped so that the interfaces through which a light beam S is to pass are at an angle to one another. For example, Yb:glass having a refractive index of n=1.5 can be used as the laser-active medium 1c. In comparison, the two diamond components have a refractive index of n=2.4. The two interfaces of the first and second component are oriented relative to one another at an opening angle δ1 of about 9.4°, so that a polarized light beam incident at first angle α2 of about 67.38° satisfies the Brewster condition. The light beam is then incident on the interface between the first component 2c and the laser-active medium 1c at a second angle β2 of about 320, which once again corresponds to the Brewster condition for the two media. The light beam is then once again incident on the interface between laser-active medium 1c and the second component 2d at a third angle γ2 of about 58° which satisfies the Brewster condition, so that, when the light beam emerges from the laser element, the conditions of entry, similar to those in FIG. 1, are duplicated and the loss on passing through is minimized.

FIG. 4 shows a fourth embodiment of the laser element according to the invention, which has first and second diamond components which are formed with a triangular cross-section. By means of this embodiment, too, laser-active media 1d having a refractive index n<2 can be used together with diamond components. In this embodiment having a refractive index assumed by way of example to be n=1.5, the light beam S enters the laser element not at the Brewster angle but at right angles to the surface, i.e. at a first angle α3 of about 90°. In this example of an embodiment, the first component 2e and the second component 2f are formed with a cross-section of an isosceles triangle. However, an embodiment according to the invention can also be realized using the cross-section of a scalene or non-isosceles triangle. The two interfaces of the first and second component are oriented relative to one another at an opening angle δ2 of about 32°, this angle corresponding to the Brewster angle of incidence of the light beam S on the interface between first component 2e and laser-active medium 1d, so that a second angle β3 of about 32° likewise results at this point, and the Brewster condition for minimizing losses is complied with. The light beam is then once again incident on the interface between laser-active medium 1d and the second component 2f at a third angle γ3 of about 58° which satisfies the Brewster condition, so that, when the light beam emerges from the laser element, the conditions of entry are duplicated and the loss on passing through is minimized. In order to reduce reflections on entry and exit, the corresponding surfaces can be provided with an antireflection coating 4.

FIG. 5 shows a further beam path according to the invention, in a fifth embodiment of the laser element. The incident light beam S enters the laser-active medium 1e, which possesses a trapezoidal cross-section and has an antireflection coating 4, directly at a first angle α4 of about 90°. The laser-active medium 1e is embedded between a first component 2g and a second component 2h comprising diamond, these components having different areas and dimensions. The two interfaces of the laser-active medium 1e which are affected by the passage of an incident light beam S are oriented relative to one another at an opening angle which corresponds to the Brewster angle of incidence of the light beam S on the interface between laser-active medium 1e and second component 2h, so that at this point entry likewise takes place in compliance with the Brewster condition. In the second component 2h, the light beam S is reflected at the interface with the air, the beam path of entry being duplicated and the light beam leaving the laser element again at a surface opposite to the entry surface. This embodiment makes it possible to use simple lamellar or disk-like diamond components in which there is no need to form exactly angled surfaces.

The angles of the beam paths shown are material-specific and serve only by way of explanation of the effect of special designs of the different embodiments and, for reasons relating to representation, may differ in their reproduction from the exact physical conditions, for example with regard to Brewster's law. In particular, no quantitative or limiting geometric information can be derived therefrom.

1. A laser element having a laser-active medium, which comprises at least
one first component of diamond and
one second component of diamond,
the laser-active medium having a heat-conductive, in particular monolithic or quasi-monolithic, connection to the first component and the second component.

2. The laser element as claimed in claim 1, wherein the first component and/or the second component have, in their connection region, the cross-section of the laser-active medium, in particular are extensively connected to the laser-active medium.

3. The laser element as claimed in claim 1, which comprises at least one antireflection coating between laser-active medium and first components and/or between laser-active medium and second components and/or on at least one outer surface of the laser element.

4. The laser element as claimed in claim 1, wherein the first component and/or the second component have an extensive form, in particular are in the form of a diamond disk or in the form of a diamond wedge.

5. The laser element as claimed in claim 1, wherein first and second component and the laser-active medium
are selected with regard to their refractive index and
are arranged relative to one another with regard to their orientation in such a way that
when light is incident on a surface of a first component or second component at the Brewster angle, light is incident on the laser-active medium at the Brewster angle.

6. The laser element as claimed in claim 1, wherein the first component and/or the second component have a triangular cross-section, in particular in the form of an isosceles triangle.

7. The laser element as claimed in claim 6, wherein the first components and second component and the laser-active medium
are formed with regard to the angle of their surfaces and
are arranged relative to one another with regard to their orientation in such a way that
when light is incident perpendicularly on a surface of the first components or second component, light is incident on the laser-active medium at the Brewster angle.

8. The laser element as claimed in claim 1, wherein the laser-active medium has a trapezoidal cross-section.

9. The laser element as claimed in claim 8, wherein first component and second component and the laser-active medium
are formed with regard to the angle of their surfaces and
are arranged relative to one another with regard to their orientation in such a way that
when light is incident perpendicularly on a surface of the laser-active medium, light is incident at the Brewster angle on the second component, reflection taking place in this second component.
